(19) United States
(12) Patent Application Publication
(10) Pub. No.: US 2025/0184457 A1
(43) Pub. Date: Jun. 5, 2025

(54) IMAGE GENERATION UNIT AND PROJECTION DISPLAY APPARATUS

(71) Applicant: Panasonic Holdings Corporation, Osaka (JP)

(72) Inventor: Yuki YAMAGATA, Osaka (JP)

(21) Appl. No.: 19/050,600

(22) Filed: Feb. 11, 2025

Related U.S. Application Data
(63) Continuation of application No. PCT/JP2023/027519, filed on Jul. 27, 2023.

(30) Foreign Application Priority Data
Aug. 18, 2022 (JP) 2022-130562

(51) Int. Cl. H04N 9/31; G03B 21/20

(52) U.S. Cl. CPC H04N 9/3158; G03B 21/2066

(57) ABSTRACT

An image generation unit includes: three light modulation elements of a first, a second, and a third light modulation element that modulate illumination light to generate image light; and a color separator-combiner prism that includes a first, a second, and a third prism guiding the illumination light to the first, the second, and the third light modulation element, respectively, in which between the second prism and the third prism, an adhesive surface and an air gap are provided, the adhesive surface being bonded over a range including a first region from which the image light is emitted and a second region through which the illumination light passes, the air gap being formed over a range including a third region that receives, among OFF light generated by the third light modulation element, OFF light reflected by a dichroic mirror surface between the first prism and the second prism.

### BACKGROUND

### 1. Technical Field

The present disclosure relates to an image generation unit and a projection display apparatus including the image generation unit.

### 2. Description of the Related Art

In recent years, projection display apparatuses (projectors) using digital micromirror devices (DMD) have been developed and are beginning to spread. In the digital micromirror device, in addition to ON light that becomes image light optically modulated based on an image signal, OFF light that does not appear in the image signal and is not used as the image light is generated. For this reason, it is necessary to direct the OFF light in a direction different from that of the image light, and for example, a technology in which the OFF light from the DMD is not incident on a color separator-combiner prism is disclosed (see, for example, Patent Literature (PTL) 1).

PTL 1: Unexamined Japanese Patent Publication No. 2015-81931

### SUMMARY

Furthermore, as illustrated in FIG. 8, OFF lights 9a, 9b, 9c generated in the respective light modulation elements are directed so as to be away from image lights 11a, 11b, 11c centered on the optical axis, and guided to light shielding plate 14 on the upper side.

However, some of OFF lights 9a, 9b, 9c may be reflected by dichroic mirror surface 133, transmitted through second prism 136, and incident on third prism 137. Reflected OFF light 16 may be reflected by upper surface 12 of third prism 137, and further reflected by bottom surface 22 of third prism 137 to cause the bases (not illustrated) provided in the Y direction of prisms 134, 136, 137 to generate heat.

Therefore, an object of the present disclosure is to provide an image generation unit capable of suppressing heat generation by reflected OFF light even in a case where a part of the OFF light is reflected by a dichroic mirror surface between a first prism and a second prism and returns to the second prism.

An image generation unit according to the present disclosure includes: three light modulation elements of a first light modulation element, a second light modulation element, and a third light modulation element that modulate illumination light based on an image signal to generate image light; and a color separator-combiner prism that includes a first prism, a second prism, and a third prism guiding the illumination light to the first light modulation element, the second light modulation element, and the third light modulation element, respectively, the first prism, the second prism, and the third prism being arranged in order along a direction of an optical axis of the image light, in which between the second prism and the third prism, an adhesive surface and an air gap are provided, the adhesive layer being bonded over a range including a first region from which the image light is emitted and a second region through which the illumination light passes, and the air gap being formed over a range including a third region that receives, among OFF light generated by the third light modulation element, OFF light reflected by a dichroic mirror surface between the first prism and the second prism.

A projection display apparatus according to the present disclosure includes: a light source section that generates light; a light guide optical system that guides light from the light source section; the image generation unit that modulates the light guided from the light guide optical system based on the image signal to generate the image light; and a projection optical system that projects the image light.

According to the image generation unit and the projection display apparatus using the image generation unit according to the present disclosure, even in a case where a part of the OFF light is reflected by the dichroic mirror surface between the first prism and the second prism and returns to the second prism, heat generation by the reflected OFF light can be suppressed.

### BRIEF DESCRIPTION OF THE DRAWINGS

FIG. 1 is a block diagram illustrating a configuration of a projection display apparatus including an image generation unit according to a first exemplary embodiment.

FIG. 2 is a schematic view illustrating an optical system of the projection display apparatus including the image generation unit in FIG. 1.

FIG. 3 is a schematic perspective view illustrating a TIR prism and a color separator-combiner prism in the projection display apparatus according to the first exemplary embodiment.

FIG. 4 is a schematic view of the TIR prism and the color separator-combiner prism in FIG. 3 as viewed from the Z direction.

FIG. 5 is a schematic view of the TIR prism and the color separator-combiner prism in FIG. 3 as viewed from the −Y direction.

FIG. 6 is a schematic view illustrating an adhesive surface and an air gap on a surface between a second prism and a third prism in FIG. 5.

FIG. 7 is a schematic perspective view illustrating a TIR prism and a color separator-combiner prism in a projection display apparatus according to a reference example.

FIG. 8 is a schematic view of the TIR prism and the color separator-combiner prism in FIG. 7 as viewed from the +Z direction.

FIG. 9 is a schematic view of the TIR prism and the color separator-combiner prism in FIG. 7 as viewed from the −Y direction.

### DETAILED DESCRIPTIONS

### Background to the Present Disclosure

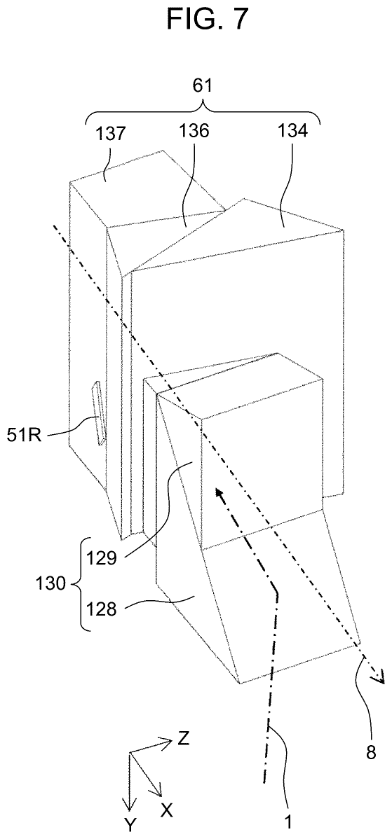

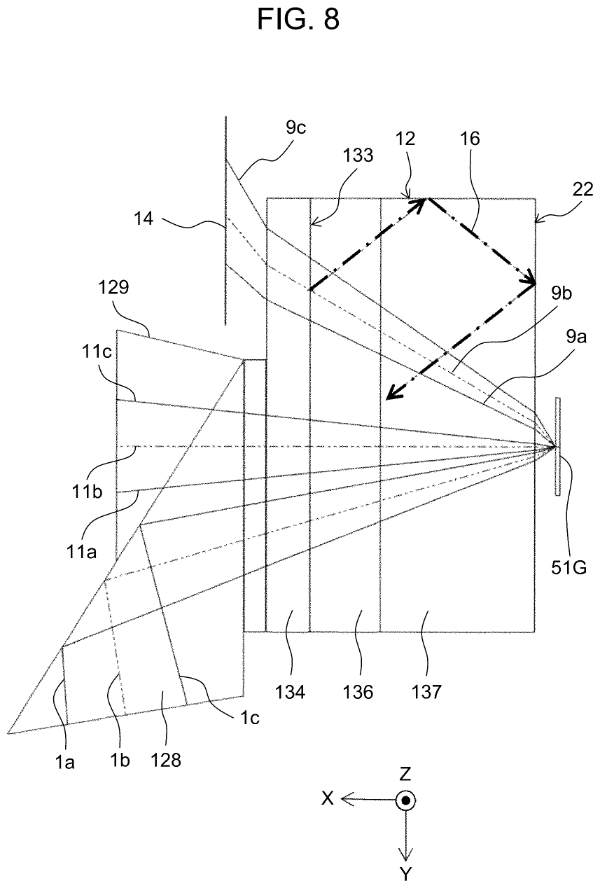

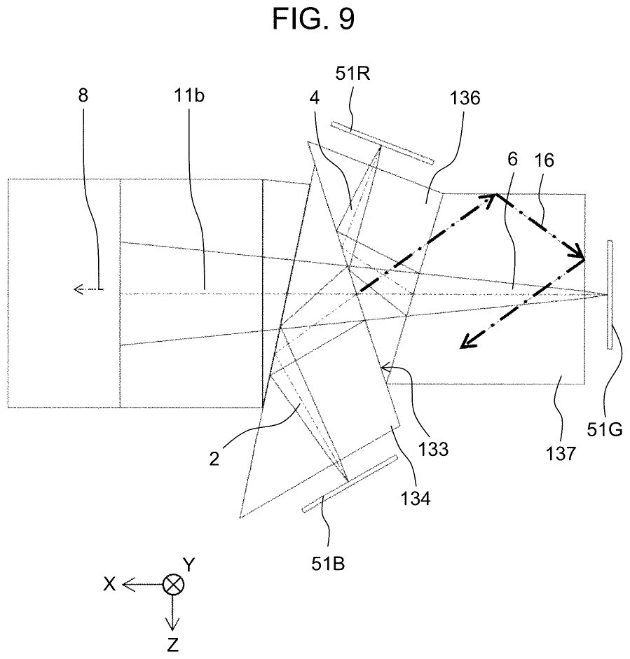

FIG. 7 is a schematic perspective view illustrating TIR prisms 128, 129 and color separator-combiner prism 61 (134, 136, 137) in a projection display apparatus according to a reference example. FIG. 8 is a schematic view of TIR prisms 128, 129 and color separator-combiner prism 61 (134, 136, 137) in FIG. 7 as viewed from the −Z direction. FIG. 9 is a schematic view of TIR prisms 128, 129 and color separator-combiner prism 61 (134, 136, 137) in FIG. 7 as viewed from the −Y direction.

As described above, heat generation in a case where a part of the OFF light is reflected by dichroic mirror surface 133 between the first prism and the second prism and returns to second prism 136 and third prism 137 has not been assumed so far.

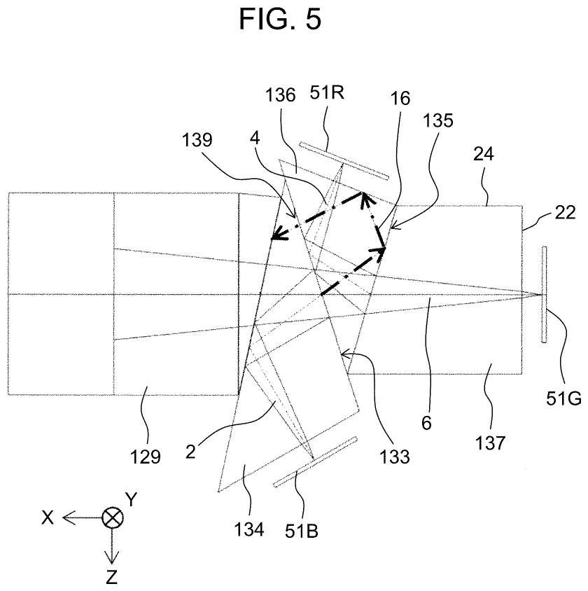

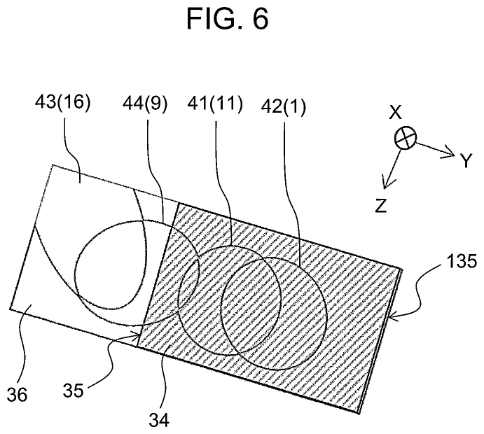

As a result of intensive studies, as illustrated in FIGS. 5 and 6, the present inventors have found that reflected OFF light 16 can be reflected by forming air gap 36 in a range including a third region on surface 135 between second prism 136 and third prism 137, the third region receiving the OFF light reflected by dichroic mirror surface 133 between the first prism and the second prism. In this case, on surface 135 between second prism 136 and third prism 137, a range including the first region from which the image light is emitted and the second region through which the illumination light passes is bonded, so that image lights 11a, 11b, 11c and the illumination light can be transmitted. By combining these, the configuration of the image generation unit according to the present disclosure has been achieved.

An image generation unit according to a first aspect includes: three light modulation elements of a first light modulation element, a second light modulation element, and a third light modulation element that modulate illumination light based on an image signal to generate image light; and a color separator-combiner prism that includes a first prism, a second prism, and a third prism guiding the illumination light to the first light modulation element, the second light modulation element, and the third light modulation element, respectively, the first prism, the second prism, and the third prism being arranged in order along a direction of an optical axis of the image light, in which between the second prism and the third prism, an adhesive surface and an air gap are provided, the adhesive surface being bonded over a range including a first region from which the image light is emitted and a second region through which the illumination light passes, and the air gap being formed over a range including a third region that receives, among OFF light generated by the third light modulation element, OFF light reflected by a dichroic mirror surface between the first prism and the second prism.

In an image generation unit according to a second aspect, in the first aspect, a boundary between the adhesive surface and the air gap on a surface between the second prism and the third prism may be provided between the first region and the second region, and the third region that receives the OFF light reflected by the dichroic mirror surface.

In an image generation unit according to a third aspect, in the first or second aspect, an air gap may be provided in a part of a fourth region through which OFF light passes.

A projection display apparatus according to a fourth aspect includes: a light source section that generates light; a light guide optical system that guides the light from the light source section; the image generation unit according to any one of the first to third aspects that modulates the light guided from the light guide optical system based on the image signal to generate the image light; and a projection optical system that projects the image light.

An image generation unit and a projection display apparatus according to an exemplary embodiment will be described below with reference to the accompanying drawings. Note that, in the drawings, substantially the same members are denoted by the same reference numerals.

### FIRST EXEMPLARY EMBODIMENT

### Projection Display Apparatus (Projector)

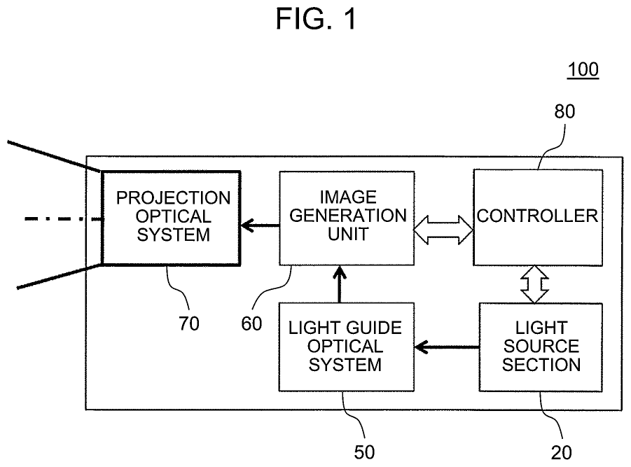

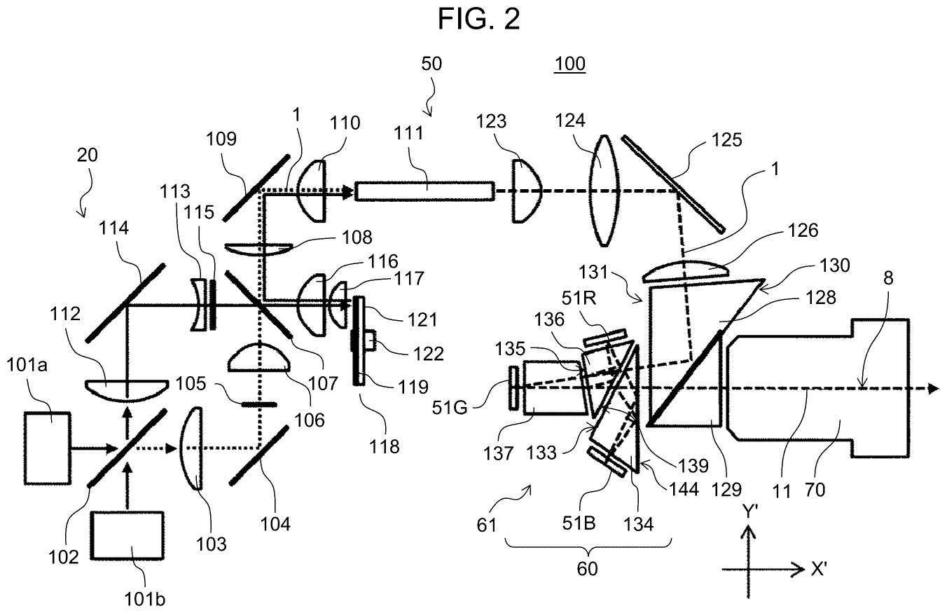

FIG. 1 is a block diagram illustrating a configuration of projection display apparatus (projector) 100 including an image generation unit according to a first exemplary embodiment. FIG. 2 is a schematic view illustrating an optical system of projection display apparatus 100 including image generation unit 60 in FIG. 1.

Projection display apparatus 100 according to the first exemplary embodiment includes light source section 20, light guide optical system 50, image generation unit 60, projection optical system 70, and controller 80. Light guide optical system 50 is an optical system that guides light from light source section 20 to image generation unit 60. Image generation unit 60 separates light into three primary colors of RGB by color separator-combiner prism 61, and modulates each of the RGB light with an image signal by a digital micromirror device (DMD) to generate image light. Projection optical system 70 projects the generated image light onto a screen or the like to form an image. Controller 80 controls light source section 20, light guide optical system 50, image generation unit 60, and projection optical system 70 described above.

Each member constituting projection display apparatus 100 will be described below.

### Light Source Section

Light source section 20 mainly includes first light source unit 101a, second light source unit 101b, separating and combining mirror 102, and phosphor wheel 118. Furthermore, light source section 20 further includes lens groups 103, 106, 113, 116, 117 and mirror groups 104, 114.

For example, first light source unit 101a and second light source unit 101b may be configured with a plurality of solid-state light sources such as a laser diode (LD) or a light emitting diode (LED). In the first exemplary embodiment, among laser diodes, a laser diode that emits blue light is particularly used as the solid-state light source. Here, the laser diode is a type of a laser light source.

The light emitted from first light source unit 101a and second light source unit 101b is, for example, blue light having a wavelength of between 440 nm and 470 nm (inclusive). This blue light is also used as excitation light for exciting phosphor 119 of phosphor wheel 118.

### Phosphor Wheel

Phosphor wheel 118 rotates about rotation shaft 122 extending along the optical axis of the excitation light. Phosphor wheel 118 is a reflection type phosphor wheel that emits fluorescence in a direction opposite to the incident direction of the excitation light. That is, phosphor wheel 118 includes substrate 121, phosphor 119 annularly applied and formed on substrate 121 along the rotation direction of substrate 121, and a motor (not illustrated) for rotating substrate 121 on which phosphor 119 is formed. Note that a reflecting film for reflecting fluorescence light emitted from phosphor 119 is formed on the surface of substrate 121. Phosphor 119 emits fluorescence including yellow light according to excitation light emitted from first light source unit 101a and second light source unit 101b.

The excitation light is diffused by top hat diffusion element 115 and condensed on phosphor 119 by lenses 116 and 117 to emit fluorescence.

The phosphor is an example of a light emitter, and is, for example, a phosphor that emits fluorescence in a main wavelength range from green to yellow. Phosphor 119 is preferably a phosphor that efficiently absorbs blue excitation light to efficiently emit fluorescence and has high resistance to temperature quenching. Phosphor 119 is, for example, Y₃A₁₅O₁₂:Ce₃₊, which is a phosphor having a garnet structure activated by cerium.

From light source section 20, light 1 including excitation light of blue light and fluorescence of yellow light is guided to light guide optical system 50.

### Light Guide Optical System

Light guide optical system 50 is an optical system that guides light 1 from light source section 20 to image generation unit 60. Light guide optical system 50 mainly includes rod integrator 111, lens groups 108, 110, 123, 124, and mirror groups 109, 125.

Rod integrator 111 is, for example, a solid rod made of a transparent member such as glass. Rod integrator 111 can make spatial intensity distributions of excitation light emitted from first light source unit 101a and second light source unit 101b and fluorescence from phosphor wheel 118 uniform. Note that, rod integrator 111 may be a hollow rod the inner wall of which is formed of a mirror surface. Rod integrator 111 is a type of light uniformizing element.

### Image Generation Unit

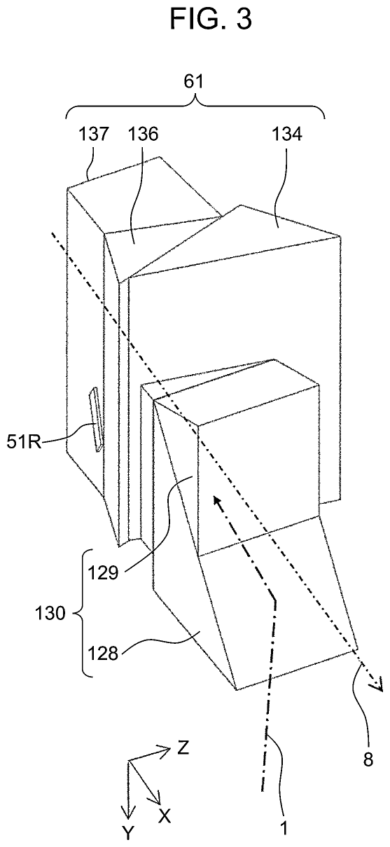

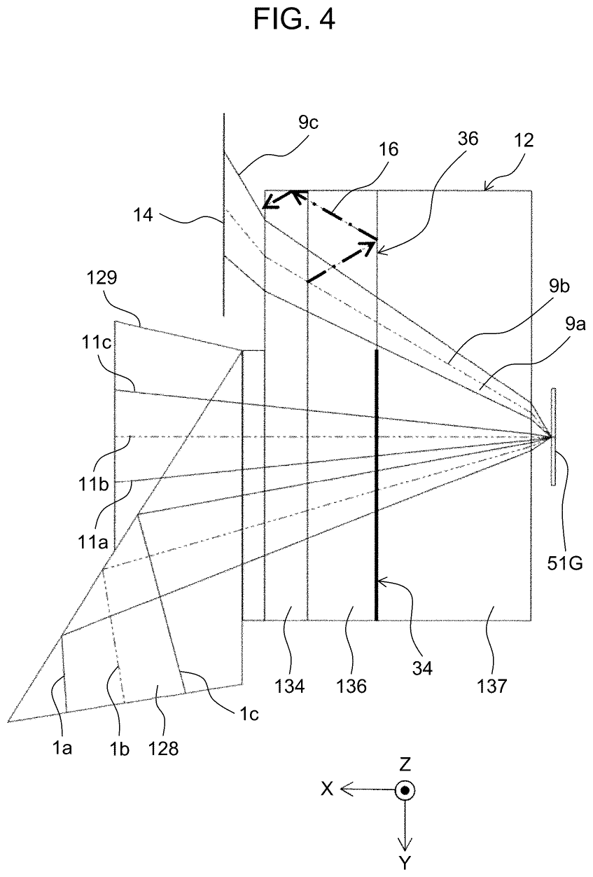

FIG. 3 is a schematic perspective view illustrating TIR prisms 128, 129 and color separator-combiner prism 61 (134, 136, 137) in projection display apparatus 100 according to the first exemplary embodiment. FIG. 4 is a schematic view of TIR prisms 128, 129 and color separator-combiner prism 61 (134, 136, 137) in FIG. 3 as viewed from the Z direction. FIG. 5 is a schematic view of TIR prisms 128, 129 and color separator-combiner prism 61 (134, 136, 137) in FIG. 3 as viewed from the −Y direction.

Note that, for convenience, in FIG. 3, the direction of optical axis 8 of the image light generated by each light modulation element (DMD) is indicated as the +X direction. Furthermore, in each drawing, the height direction of each prism (134, 136, 137) having a triangular shape of color separator-combiner prism 61 is represented as the −Y direction. Moreover, the Z direction perpendicular to the X direction and the Y direction is also shown.

Image generation unit 60 includes TIR prisms 128, 129 that guide illumination light 1 from light guide optical system 50 to color separator-combiner prism 61, color separator-combiner prism 61 including three prisms of first prisms 134, second prism 136, and third prism 137 that separate and combine illumination light 1 into three primary colors of RGB, and first DMD (51B), second DMD (51R), and third DMD (51G), which are three digital micromirror devices (DMD) that generate image light by modulating based on the respective image signals of the separated three primary colors of RGB.

Moreover, similarly to the reference example illustrated in FIG. 8, image generation unit 60 may include light shielding plate 14 that is provided on the front side of optical axis 8 of first prism 134 and absorbs a part of the OFF light generated by third modulation element 51G and transmitted through third prism 137, second prism 136, and first prism 134.

### TIR Prism

TIR prisms 128, 129 guide illumination light 1 from light guide optical system 50 to color separator-combiner prism 61. TIR prism 128 is formed of a light-transmissive member, and has surface 130 facing TIR prism 129 and surface 131 facing first prism 134 of color separator-combiner prism 61. An air gap is provided between TIR prism 128 (FIG. 2: surface 130) and TIR prism 129, and the incident angle at which the light incident on TIR prism 128 is incident on surface 130 is larger than the critical angle, so that the light incident on TIR prism 128 is reflected by surface 130. On the other hand, an air gap is provided between TIR prism 128 (FIG. 2: surface 131) and first prism 134 (FIG. 2: surface 144), but the angle (incident angle) at which the light reflected by surface 130 is incident on surface 131 is smaller than the critical angle, so that the light reflected by surface 130 is transmitted through surface 131.

### Light Modulation Element: Digital Micromirror Device (DMD)

Light modulation elements 51G, 51R, 51B are, for example, digital micromirror devices (DMD). First DMD (51B), second DMD (51R), and third DMD (51G), which are digital micromirror devices, are configured by a plurality of movable micro mirrors, and each micro mirror corresponds to one pixel. In first DMD (51B), second DMD (51R), and third DMD (51G), by changing the angle of each micro mirror based on the image signal, whether or not light is reflected to the side of projection unit 70 is switched to generate image light. First DMD (51B) is a type of first light modulation element. Second DMD (51R) is a type of second light modulation element. Third DMD (51G) is a type of third light modulation element.

Note that the light guided to first DMD (51B) is first component light (blue component light) dispersed from light 1 guided from light guide optical system 50. The light modulated by first DMD (51B) is first modulation light 2. Similarly, the light guided to second DMD (51R) is dispersed second component light (red component light). The light modulated by second DMD (51R) is second modulation light 4. Furthermore, the light guided to third DMD (51G) is dispersed third component light (green component light). The light modulated by third DMD (51G) is third modulation light 6.

In first DMD (51B), second DMD (51R), and third DMD (51G), as illustrated in FIGS. 4 and 8, first modulation light 2, second modulation light 4, and third modulation light 6, which are the ON light as the image light, are emitted, and OFF lights 9a, 9b, 9c, which are not the image light, are emitted while deviated from the optical axis (X direction). Note that first modulation light 2, second modulation light 4, and third modulation light 6 respectively indicate image light emitted along widths of first DMD (51B), second DMD (51R), and third DMD (51G). Similarly, OFF lights 9a, 9b, 9c indicate the OFF lights emitted along the width of third DMD (51G).

FIG. 4 illustrates only OFF lights 9a, 9b, 9c from third DMD (51G), which is the third modulation element. In the drawing, OFF lights emitted from other first DMD (51B) and second DMD (51R) are omitted.

### Color Separator-Combiner Prism

Color separator-combiner prism 61 is formed of a light-transmissive member, and includes first prism 134, second prism 136, and third prism 137 arranged in order along the direction of optical axis 8. Color separator-combiner prism 61 may be, for example, a dichroic prism-Phillips type. Surface 133 of first prism 134 is, for example, a dichroic mirror surface that transmits the red component light and the green component light and reflects the blue component light. Therefore, of light 1 reflected by surface 130 of TIR prism 128, the red component light and the green component light are transmitted through surface 133, and the blue component light is reflected by surface 133. The blue component light reflected by surface 133 is reflected by surface 144 and guided to first DMD (51B). Surface 135 of second prism 136 is a dichroic mirror surface that transmits the green component light and reflects the red component light. Therefore, of the light incident on second prism 136, the green component light is transmitted through surface 135, and the red component light is reflected by surface 135. The red component light reflected by surface 135 is guided to second DMD (51R). The green component light transmitted through surface 135 of second prism 136 and incident on third prism 137 is guided to third DMD (51G).

Note that the component light guided by first prism 134 and second prism 136 may be exchanged, the red component light may be guided to the first DMD by first prism 134, and the blue component light may be guided to the second DMD by second prism 136.

That is, the blue component light, the red component light, and the green component light are light dispersed by color separator-combiner prism 61.

Furthermore, as illustrated in FIG. 5, first prism 134 receives blue image light 2, which is the first modulation light modulated by first DMD (51B), and guides blue image light 2 to the optical path along optical axis 8. Furthermore, similarly to the reference example, second prism 136 receives red image light 4, which is the second modulation light modulated by second DMD (51R), and guides red image light 4 to the optical path along optical axis 8. Third prism 137 receives green image light 6, which is the third modulation light modulated by third DMD (51G), and guides green image light 6 to the optical path along optical axis 8.

That is, blue image light 2, red image light 4, and green image light 6 are combined in the same optical path along optical axis 8 by color separator-combiner prism 61 to become image lights 11a, 11b, 11c, respectively.

As illustrated in FIG. 8, OFF lights 9a, 9b, 9c emitted from third modulation element (51G) are absorbed by light shielding plate 14 via third prism 137, second prism 136, and first prism 134.

However, as illustrated in FIGS. 8 and 9, in the configuration of the conventional image generation unit, for example, OFF light 9b may be reflected by dichroic mirror surface 133 between first prism 134 and second prism 136, and reflected OFF light 16 may return to second prism 136 as unnecessary light and reach third prism 137. In such a case, reflected OFF light 16 may be reflected by upper surface 12 of third prism 137, and further reflected by bottom surface 22 of third prism 137 to cause the bases (not illustrated) provided in the Y direction of prisms 134, 136, 137 to generate heat. For example, in the case of several tens of kilo-lumens (klm), the heat generation may reach several tens of watts.

### Surface Between Second Prism and Third Prism

FIG. 6 is a schematic view illustrating adhesive surface 34 and air gap 36 on surface 135 between second prism 136 and third prism 137 in FIG. 5.

In image generation unit 60 according to the first exemplary embodiment, adhesive surface 34 is formed on surface 135 between second prism 136 and third prism 137, adhesive surface 34 being bonded over a range including first region 41 (11) through which image light 11 is emitted and second region 42 (1) through which illumination light 1 passes. By bonding a part in this way, the optical efficiency of the prism can be improved (2 to 3%), and the image quality can be improved by improving focus variation and color deviation due to APL. Furthermore, on surface 135 between second prism 136 and third prism 137, air gap 36 is formed over a range including third region 43 (16) that receives OFF light 16 reflected by dichroic mirror surface 133 between first prism 134 and second prism 136 among OFF light 9 generated by the third light modulation element (51G).

Note that, in FIG. 6, first region 41 (11), second region 42 (1), and third region 43 (16) are all represented by a circle or an ellipse, but the present invention is not limited thereto. For example, these regions may be represented by a rectangle such as a rectangle or a square, or a polygon.

Boundary 35 between bonded adhesive surface 34 and formed air gap 36 on surface 135 between second prism 136 and third prism 137 is provided between first region 41 from which image light 11 is emitted and second region 42 through which illumination light 1 passes, and third region 43 that receives OFF light 16 reflected by dichroic mirror surface 133.

On surface 135 between second prism 136 and third prism 137, as illustrated in FIGS. 4 and 6, air gap 36 and adhesive surface 34 are disposed along the Y direction. That is, air gap 36 is disposed on the −Y direction side, and adhesive surface 34 is disposed on the +Y direction side.

On surface 135 between second prism 136 and third prism 137, air gap 36 may be provided in a part of fourth region 44 (9) through which OFF light 9 passes. Note that since fourth region 44 (9) of OFF light 9 may partially overlap first region 41 (11) of image light 11 on surface 135, the air gap cannot be disposed in the whole of fourth region 44 (9).

Fourth region 44 (9) is represented by an elliptical shape in FIG. 6, but the present invention is not limited thereto. For example, these regions may be represented by a rectangle such as a rectangle or a square, a polygon or a circle.

### Effects

On surface 135 between second prism 136 and third prism 137, air gap 36 disposed on the −Y direction side allows reflected OFF light 16 to be reflected by surface 135 on which air gap 36 is disposed and guided to light shielding plate 14 as illustrated in FIGS. 4 and 5. Note that, in FIG. 5, a change in the optical path in the Y direction cannot be grasped, and it looks like an optical path similar to the optical path of image light 11, but as illustrated in FIG. 4, reflected OFF light 16 is guided to light shielding plate 14 provided in the −Y direction. By forming the interface with air as surface 135 with respect to second prism 136, OFF light 16 reflected from second prism 136 is easily totally reflected. As a result, heat generation by reflected OFF light 16 can be suppressed.

Furthermore, on surface 135 between second prism 136 and third prism 137, illumination light 1 and image light 11 can pass through adhesive surface 34 disposed on the +Y direction side. Since no air is present across surface 135, illumination light 1 and image light 11 can easily pass therethrough. Furthermore, as described above, the optical efficiency of the prism can be improved, and the image quality can be improved.

### Projection Optical System

Projection optical system 70 projects generated image light 11 onto a screen or the like to form an image.

### Controller

Controller 80 controls light source section 20, light guide optical system 50, image generation unit 60, and projection optical system 70 described above.

Note that the present disclosure includes appropriate combination of arbitrary exemplary embodiments and/or examples among the various exemplary embodiments and/or examples described above, and effects of the respective exemplary embodiments and/or examples can be exhibited.

According to the image generation unit and the projection display apparatus using the image generation unit of the present disclosure, even in a case where a part of the image light becomes unnecessary light and is transmitted through the prism, the heat generation in the prism due to the unnecessary light can be suppressed.

### REFERENCE MARKS IN THE DRAWINGS

1 light from light source (illumination light)
1a, 1b, 1c illumination light
2 blue image light
4 red image light
6 green image light
8 optical axis
9 OFF light
9a, 9b, 9c OFF light
11 image light
11a, 11b, 11c image light
12 upper surface
14 light shielding plate
16 reflected OFF light (unnecessary light)
20 light source section
22 bottom surface
34 adhesive surface
36 air gap
41 first region (11)
42 second region (1)
43 third region (16)
44 fourth region (9)
50 light guide optical system
51B first light modulation element (first DMD)
51R second light modulation element (second DMD)
51G third light modulation element (third DMD)
60 image generation unit
61 color separator-combiner prism
70 projection optical system (projection unit)
100 projection display apparatus
101a first light source unit
101b second light source unit
102 separating and combining mirror
103, 106, 108, 110, 112, 113, 116, 117, 123, 124, 126 lens
104, 109, 114, 125 mirror
105 diffuser plate
107 dichroic mirror
111 rod integrator
115 top hat diffusion element
118 phosphor wheel
119 phosphor
122 rotation shaft
128, 129, 134, 136, 137 prism
130, 131, 133, 135, 139, 144 surface

What is claimed is:

1. An image generation unit comprising:
three light modulation elements of a first light modulation element, a second light modulation element, and a third light modulation element that modulate illumination light based on an image signal to generate image light; and
a color separator-combiner prism that includes a first prism, a second prism, and a third prism guiding the illumination light to the first light modulation element, the second light modulation element, and the third light modulation element, respectively, the first prism, the second prism, and the third prism being arranged in order along a direction of an optical axis of the image light,
wherein
between the second prism and the third prism, an adhesive surface and an air gap are provided,
the adhesive surface being bonded over a range including a first region from which the image light is emitted and a second region through which the illumination light passes, and
the air gap being formed over a range including a third region that receives, among OFF light generated by the third light modulation element, OFF light reflected by a dichroic mirror surface between the first prism and the second prism.

2. The image generation unit according to claim 1, wherein a boundary between the adhesive surface and the air gap on a surface between the second prism and the third prism is provided between the first region and the second region, and the third region that receives the OFF light reflected by the dichroic mirror surface.

3. The image generation unit according to claim 1, wherein on a surface between the second prism and the third prism, an air gap is provided in a part of a fourth region through which OFF light passes.

4. A projection display apparatus comprising:
a light source section that generates light;
a light guide optical system that guides the light from the light source section;
the image generation unit according to claim 1 that modulates the light guided from the light guide optical system based on the image signal to generate the image light; and
a projection optical system that projects the image light.
